(19) United States
(12) Patent Application Publication
(10) Pub. No.: US 2021/0365559 A1
(43) Pub. Date: Nov. 25, 2021

(54) SEAMLESS SYSTEM MANAGEMENT MODE CODE INJECTION

(71) Applicant: Intel Corporation, Santa Clara, CA (US)

(72) Inventors: Sarathy Jayakumar, Portland, OR (US); Jiewen Yao, Shanghai (CN); Murugasamy Nachimuthu, Beaverton, OR (US); Ruixia Li, Shanghai (CN); Siyuan Fu, Shanghai (CN); Chuan SONG, Shanghai (CN); Wei Xu, Shanghai (CN)

(21) Appl. No.: 17/392,012

(22) Filed: Aug. 2, 2021

Related U.S. Application Data
(60) Provisional application No. 63/082,627, filed on Sep. 24, 2020.

(51) Int. Cl. G06F 21/57

(52) U.S. Cl. CPC G06F 21/572; G06F 2221/033

(57) ABSTRACT

Methods and apparatus for seamless system management mode (SMM) code injection. A code injection listener is installed in BIOS during booting of the computer system or platform. During operating system (OS) runtime operation a secure execution mode code injection image comprising injected code is received and delivered to the BIOS. The processor execution mode is switched to a secure execution mode such as SMM, and while in the secure execution mode the injected code is accessed and executed on the processor to effect one or more changes such as patching processor microcode, a profile or policy reconfiguration, and a security fix. The solution enables platform changes to be effected during OS runtime without having to reboot the system.

### CLAIM OF PRIORITY

This application claims the benefit of and priority to U.S. Provisional Application No. 63/082,627, filed Sep. 24, 2020, the entire contents of which is incorporated herein by reference in its entirety.

### BACKGROUND INFORMATION

The business model of at-scale deployment of a fleet of servers, drives the imperative that system resets should be avoided and should only be treated as an option of last resort. This is driven by the fact that Cloud Service Providers (CSPs) would incur significant cost of system downtime and workload disruption caused by system resets or Kernel Restarts. At the same time, increasingly, there are CSP demands for runtime reconfiguration, security fixes, etc.

This poses a few problems. For example, one problem results from injecting a platform configuration/behavior change or security fix. These are typically a one-time injection of a profile or policy reconfiguration, or a security fix to lock a register down. For instance, there could be some performance knobs or error severity mapping that need to be reconfigured, or a need to lock a register as result of a security fix. In addition, these configuration registers could be protected by SMM (System Management Mode) privileges (e.g., only code with SMM privileges will be able to modify them). Even if they are Ring-0 accessible, it would require a significant Operating System (OS) enabling effort/Kernel changes that will require a Kernel restart, which is disruptive.

Under another problem a vendor provides microcode (uCode) patches for processor bug/security fixes. Oftentimes, a given uCode patch can produce a new Machine Specific Register (MSR) for certain configurations, that would need to be programmed to make it effective. Today, an OS kernel patch must be provided before the uCode update release. The customer must patch their OS kernel ahead of the uCode patch update, and this typically would require kernel patching, and platform/kernel reset, which is disruptive. These require a BIOS (e.g., Firmware) update and/or a Kernel update followed by a system reset/Kernel reset, for it to take effect, which goes against the ethos and requirement of avoiding highly disruptive system/kernel restarts.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a flowchart illustrating the boot flow of system BIOS, according to one embodiment;

FIG. 2 is a schematic diagram illustrating the structure of a UEFI capsule, according to one embodiment;

FIG. 3 is a flowchart illustrating operations associated with runtime SMM code injection, according to one embodiment; and

FIG. 4 is a diagram illustrating an example use of seamless SMM code injection to load a new microcode patch and update a configuration specific MSR in one single SMM code injection process, according to one embodiment;

FIG. 5 is a diagram illustrating an alternative injected image capsule delivery scheme employing an out-of-band channel using a baseboard management controller (BMC), according to one embodiment; and

FIG. 6 is a diagram of a computing platform or system that may be implemented with aspects of the embodiments described and illustrated herein.

### DETAILED DESCRIPTION

Embodiments of methods and apparatus for seamless system management mode code injection are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In embodiments disclosed herein, an ‘SMM Code Injection Listener’ is introduced as the SMM Root-of-Trust for Update (RTU) to process the SMM code injection package. To support SMM Code Injection, the embodiments includes the following:
1. A mechanism to encapsulate the new SMM firmware code and resource access metadata as Code Injection payload. One of the embodiments of this could be an UEFI capsule, but this disclosure does not prescribe any implementation direction.
2. A mechanism to authenticate the incoming image.
3. A mechanism to unlock system resources (TO, MSR, Register Context, etc.) for co-existence with system resource defense technology.
4. A mechanism to load, execute, and unload the Code Injection Image, with execution trace provided which allows roll back a previous injected code if required.

For system resource defense enabled platforms, this Code Injection Listener is adapted by the SMM policy to run in ring0 environment (unlike other de-privileged SMI handlers that runs in ring3).

In keeping with the security imperatives of such code injection, the Listener uses PKCS (Public Key Cryptography Standards) and RSA Hashing and SHA Encryption Algorithms. One embodiment uses PKCS7 (Public Key Cryptography Standards #7—Cryptographic Message Syntax) with SHA 384 Hash and RSA 1024 Encryption algorithm, though this disclosure does not prescribe the implementation choice and can be moved to SHA512/RSA1024 or better in the future.

The solutions disclosed herein are game changers in the CSP eco-system and provides immediate value to processor vendors and their customers. It allows the processor vendors and customers to react immediately to security threats, performance tuning and bug fixes, to name a few.

Reducing Costly System Downtimes:

The business model of at-scale deployment of a fleet of servers drives the imperative that system resets should be avoided and should only be treated as an option of last resort, as CSPs would incur significant cost of system downtime and workload disruption caused by system resets. At the same time, there are bug fixes, security fixes and performance tuning that needs to be deployed in a periodic and oftentimes immediate basis. Embodiments described herein solves this problem by providing a mechanism to inject an one-time code into SMM in a secure manner. This avoids the costly system reset.

Quick Deployment of Security Fixes:

Security fixes typically are delivered as part of a microcode patch update. Oftentimes, these patches add new MSRs that need to be handled by the OS. This gives rise to the need to prime the OS ecosystem (long lead-times and enabling effort) before a security fix can be delivered using a uCode patch. The embodiments solve this problem by providing a mechanism to inject a one-time payload (uCode+The code to handle the MSR) into SMM in a secure manner. This avoids long and expensive OS eco-system enabling, as well avoids System and Kernel resets.

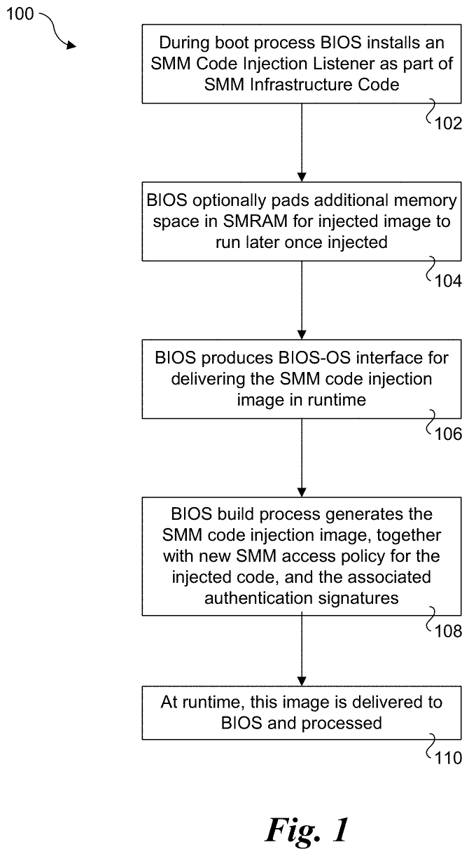

FIG. 1 shows a flowchart 100 illustrating the boot flow of system BIOS, according to one embodiment. As shown in a block 102, during boot process, the BIOS installs an SMM Code Injection Listener as part of SMM Infrastructure Code. In a block 104 the BIOS optionally pads additional memory space in System Management Random Access Memory (SMRAM) for an injected image to run later once injected. In a block 106, the BIOS produces a BIOS-OS interface for delivering the SMM code injection image in runtime. For example, some embodiments might choose an ACPI (Advance Configuration and Power Interface) method, a protected runtime mechanism, or a UEFI (Unified Extensible Firmware Interface) runtime service. BIOS can also produce an out-of-band (OOB) channel for delivering the image through a management unit (like a baseboard management controller (BMC)); for example, an OOB update of reserved flash region to stage the SMM code injection image.

In a block 108, the BIOS build process generates the SMM code injection image, together with a new SMM access policy for the injected code, and the associated authentication signatures. Subsequently, at runtime, this image is delivered to BIOS and processed, as depicted in a block 110.

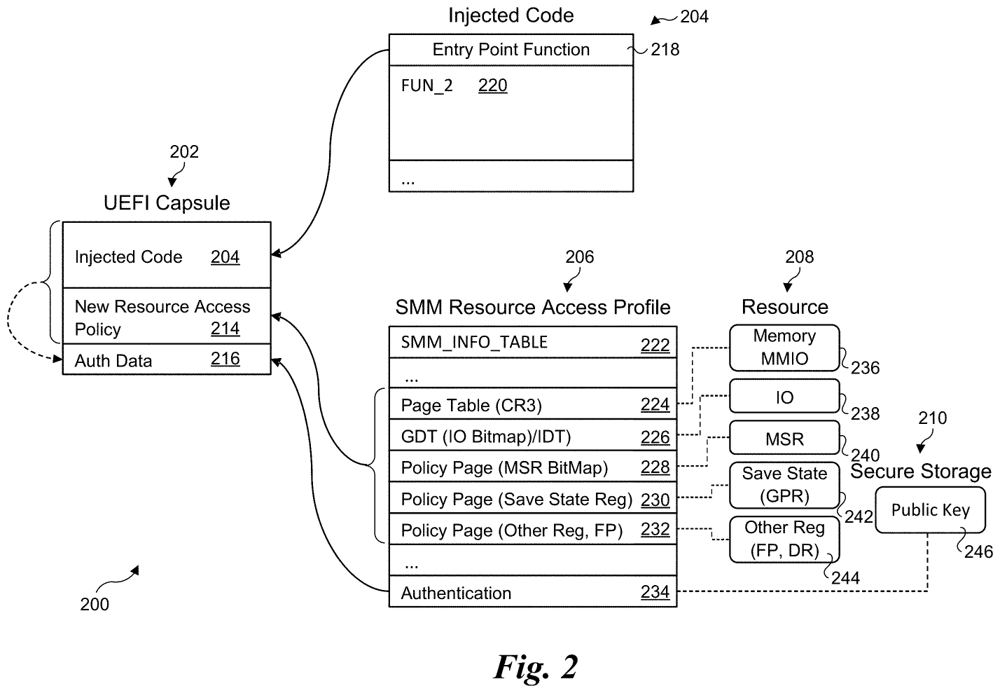

FIG. 2 shows a diagram 200 illustrating the structure of a UEFI capsule, according to one embodiment. The top-level blocks in diagram 200 include a UEFI capsule 202, injected code 204, a SMM resource access profile 206, resources 208, and secure storage 210. UEFI capsule 202 includes injected code 204, a new resources access policy 214, and authentication data (Auth Data) 216. Injected code 204 includes and entry point function 218, and one or more other functions 220.

SMM resource access profile includes an SMM information table 222, a page table 224, a GDT comprising an IO bitmap/IDT 226, policy pages 228, 230, and 232, and authentication data 234. Page table 224 include page table entries for Memory Mapped Input-Output (MMIO) memory 236. GDT 226 includes an IO resource 238. Policy page 228 comprises an MSR bitmap associated with an MSR 240. Policy page 230 includes save stage registers 242 (e.g., GPR), while policy page 232 includes other registers, such as FP and DR 244. Authentication data 234 employs a public key 246.

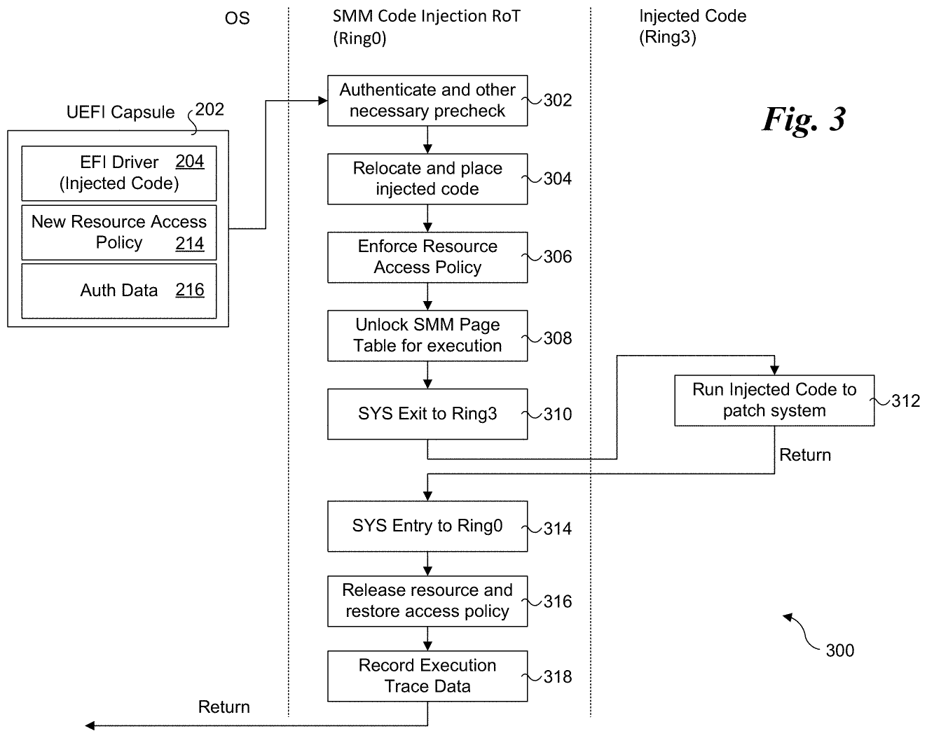

FIG. 3 shows a flowchart 300 illustrating operations associated with runtime SMM code injection, according to one embodiment. An OS agent sends a new SMM executable image to SMM Listener through the BIOS-OS interface or Out-Of-Band (00B) management channel. In this example the SMM executable image is in EFI driver 204 of UEFI capsule 202. The SMI code injection Listener prepares the environment and loads the SMM executable image into SMRAM. In a block 302, the SMI code injection Listener performs authentication and other prechecks. For example, the SMI code injection Listener verifies the SMM executable image (see under ‘security’ above). If the verification fails, the SMM Listener will reject the new SMM executable image, clean up the environment and return directly. Optionally, the Listener can perform bounds checks to ensure the injected image can execute successfully. For example, preprocess the new SMM module's CSR/MSR access rights.

In a block 304 the injected code is relocated and placed in SMRAM. The SMM Listener may also check that new Injection module is with in allocated code injection SMRAM space and not overlap with other SMRAM regions

The Listener prepares to enforce the new resource access policy for the injected code and unlock SMM page table for execution. In a block 306 a resource access policy is enforced. The SMM page table is then unlocked for execution in a block 308. Following this preparation of the environment, the SYS Exit to Ring3 in a block 310 and then executes the injected code in Ring3 to patch the system, as shown in a block 312. The injected code completes its functionality, such as writing to certain SMM privileged registers, and returns.

Following block 312, the process returns to the Listener SYS Entry to Ring0 in a block 314. The Listener then restores the original resource access policy in a block 316 and cleans up the environment. In a block 318 execution trace data is recorded. The SMM Listener then returns execution back to the OS.

The SMM Code Injection Listener allows multiple runtime SMM code injection to be scheduled in one power cycle without system reset. It is possible that a previous injected image has a defect or otherwise failed. In this case, a new ‘antidote code’ must be created and injected again to perform the rollback or a subsequent fix. In such a case, the execution trace information of previous injected SMM images are used to reproduce system state, root cause the problem and make a successful antidote code.

The SMM Code Injection Listener maintains below execution trace information during runtime code injection flow, and provides to user information such as (and not limited to):
Platform Firmware ID
SMM Code Injection Listener ID
Image Authentication Authority Information
History data of previous injected image, such as Code Injection Image ID, execution time, result data, etc.
Code Injection Image provided error code/messages indicates what happened.
Other necessary tracing information.

Using SMM Code Injection for Solving the Microcode+MSR Problem

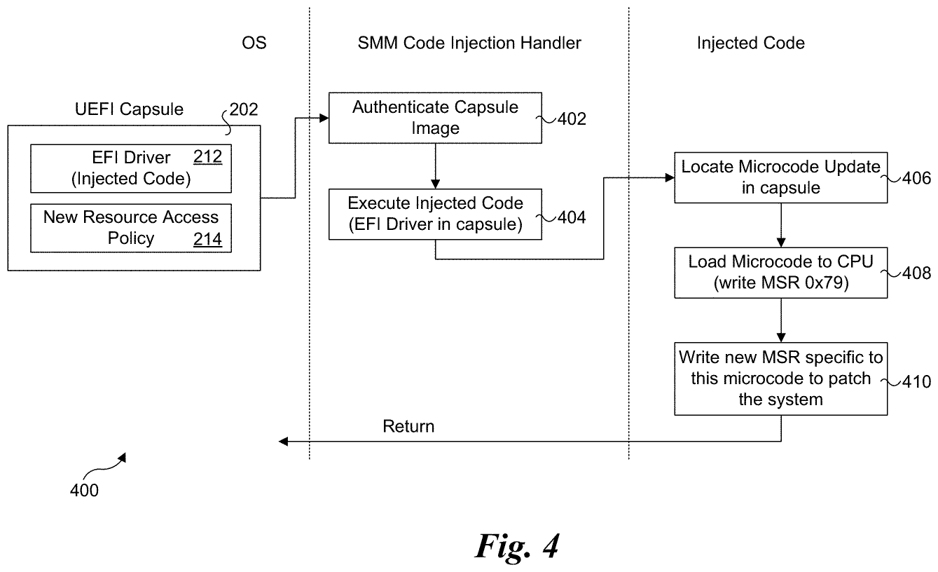

FIG. 4 shows a diagram 400 illustrating an example use of Seamless SMM Code Injection to load a new Microcode Patch and update a configuration specific MSR in one single SMM Code Injection process, without an OS kernel patching, platform reset, or kernel reset. Generally, a processor vendor provides Microcode Patches for processor bug/security fixes. Oftentimes, a given Microcode Patch can produce a new MSR for certain configurations, which would need to be programmed to make it usable.

By using the SMM Code Injection method described herein, the Microcode Update patch can be built as part of the code injection image, together with the microcode loading code and the MSR setting operation. In this way the Microcode Update loading and related MSR setting can be completed by one single SMM code injection flow, and a platform/kernel reset can be avoided.

As shown in FIG. 4, as before an OS agent sends UEFI capsule 202 to the SMM Code Injection Hander through the BIOS-OS interface or OOB management channel. The SMM Code Injection Handler authenticates the capsule image in a block 402 and executes the EFI driver in the UEFI capsule in a block 404. As depicted by blocks 406 and 408, this locates the microcode update in the capsule, loads the microcode to the CPU (or core on CPU executing the image). The new MSR specific to the microcode is then written to patch the system, as shown in a block 410. Processing then returns to the OS, completing the cycle.

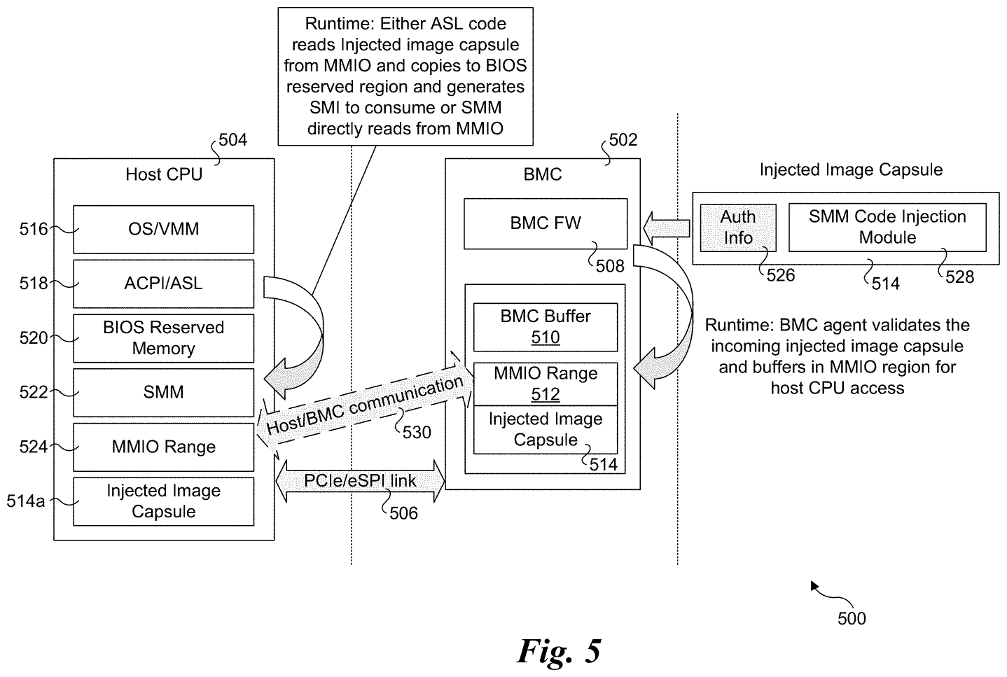

FIG. 5 shows a diagram 500 illustrating an alternative injected image capsule delivery scheme employing an OOB channel using a BMC, according to one embodiment. Diagram 500 includes a BMC 502 coupled to a host CPU 504 via a PCIe or eSPI (Enhanced Serial Peripheral Interface) link 506. BMC 502 includes BMC firmware 508, a BMC buffer 510, a Memory-Mapped Input-Output (MMIO) range 512, and an injected capsule image 514. Host CPU 504 includes an OS/Virtual Machine Monitor (VMM) 516, an ACPI/ASL (ACPI Source Language) block 518, BIOS reserved memory 520, SMM logic 522, MMIO range 524, and an injected image capsule 514a.

During OS runtime an injected image capsule 514 including authentication information 526 and an SMM code injection module 528 is received at BMC 502. For example, a BMC on a platform may be coupled to a management network or the like, or may otherwise be connected to a network or fiber interface (not shown) used for providing platform management control signals and data. Upon receiving injected image capsule 514, a BMC agent that is implemented in BMC firmware 508 is executed to validate the injected image capsule using authentication information 526. If validation passes, the injected image capsule 514 is copied to a portion of BMC buffer 510. MMIO ranges 512 and 524 are then implemented to copy injected image capsule to host CPU 504 using an OOB host/BMC communication channel 530. For example, for a PCIe link, one or more PCIe DMA transactions may be used to transfer the data.

In one embodiment, MMIO range 512 is implemented as a mailbox that has transport constructs to send and receive data via OOB host/BMC communication channel 530. In some embodiments, MMIO ranges 512 and 524 have a smaller range than the injected image capsule 514. Hence when injected image capsule 514 is sent to BMC 502, first it goes to BMC buffer 510 (either in DRAM or DRAM+flash), and after authentication it gets transported over MMIO to the host.

Example Platform/System

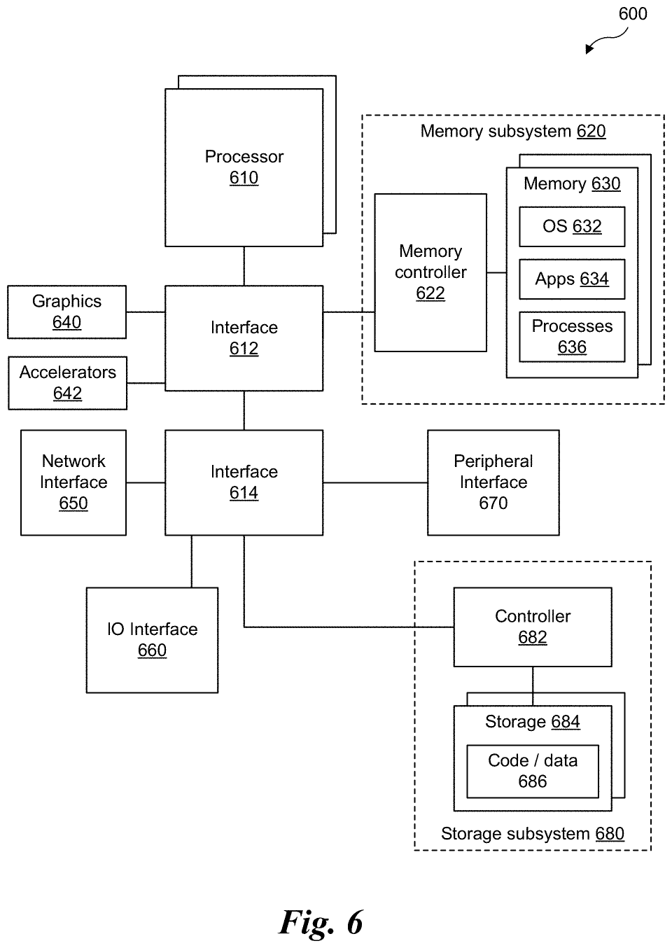

FIG. 6 depicts a computing platform 600 (also generally referred to as a computing system) in which aspects of the embodiments disclosed above may be implemented. Computing platform 600 includes one or more processors 610, which provides processing, operation management, and execution of instructions for computing platform 600. Processor 610 can include any type of microprocessor, central processing unit (CPU), graphics processing unit (GPU), processing core, multi-core processor or other processing hardware to provide processing for computing platform 600, or a combination of processors. Processor 610 controls the overall operation of computing platform 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, computing platform 600 includes interface 612 coupled to processor 610, which can represent a higher speed interface or a high throughput interface for system components that needs higher bandwidth connections, such as memory subsystem 620 or optional graphics interface components 640, or optional accelerators 642. Interface 612 represents an interface circuit, which can be a standalone component or integrated onto a processor die. Where present, graphics interface 640 interfaces to graphics components for providing a visual display to a user of computing platform 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

In some embodiments, accelerators 642 can be a fixed function offload engine that can be accessed or used by a processor 610. For example, an accelerator among accelerators 642 can provide data compression capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of computing platform 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in computing platform 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for computing platform 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that computing platform 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, computing platform 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides computing platform 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, computing platform 600 includes one or more IO interface(s) 660. IO interface 660 can include one or more interface components through which a user interacts with computing platform 600 (e.g., audio, alphanumeric, tactile/touch, or other interfacing). Peripheral interface 670 can include any hardware interface not specifically mentioned above. Peripherals refer generally to devices that connect dependently to computing platform 600. A dependent connection is one where computing platform 600 provides the software platform or hardware platform or both on which operation executes, and with which a user interacts.

In one example, computing platform 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (i.e., the value is retained despite interruption of power to computing platform 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to computing platform 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM, or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version 3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014), HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of computing platform 600. More specifically, power source typically interfaces to one or multiple power supplies in computing platform 600 to provide power to the components of computing platform 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, computing platform 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

For historical reasons, the term “BIOS” is used throughout this disclosure, including the drawings. The name itself originates from the Basic Input/Output System used in the CP/M operating system in 1975. Those skilled in the art will recognize that BIOS refers to the system firmware, such as but not limited to UEFI firmware. The techniques may also apply to other forms of BIOS and/or firmware such as BIOS/firmware used in CPUs and processors employing ARM™ architectures.

In the foregoing embodiments implementations are described and illustrated as applied to an SMM and SMM driver update use case. However, this is merely exemplary and non-limiting. More generally, the principles and teachings disclosed herein may be used to perform runtime updates of secure execution mode firmware components, including secure execution mode infrastructure components. As used herein, including the claims, secure execution mode is an execution mode of the processor during which execution of an operating system is paused and provides access to firmware code and hardware that is otherwise not accessible outside of the secure execution mode.

In addition to applying secure execution mode firmware for computing platforms with CPUs, the teaching and principles disclosed herein may be applied to Other Processing Units (collectively termed XPUs) including one or more of Graphic Processor Units (GPUs) or General Purpose GPUs (GP-GPUs), Tensor Processing Unit (TPU) Data Processor Units (DPUs), Artificial Intelligence (AI) processors or AI inference units and/or other accelerators, FPGAs and/or other programmable logic (used for compute purposes), etc. While some of the diagrams herein show the use of CPUs, this is merely exemplary and non-limiting. Generally, any type of XPU may be used in place of a CPU in the illustrated embodiments. Moreover, as used in the following claims, the term “processor” is used to generically cover CPUs and various forms of XPUs.

In addition to CPU/processor BIOS, techniques similar to those disclosed herein may apply to XPU BIOS and/or firmware, such as GPU vBIOS, for example.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented on a computing system including a processor, BIOS, and an operating system (OS) comprising:
installing a code injection listener in BIOS during booting of the computer system;
during OS runtime operation of the computing system,
receiving a secure execution mode code injection image;
delivering the secure execution mode code injection image to BIOS;
switching to a secure execution mode and while in the secure execution mode,
accessing injected code from the secure execution mode code injection image;
executing injected code on the processor; and
exiting the secure execution mode and returning to OS runtime operation.

2. The method of claim 1, wherein the processor includes microcode (uCode), wherein the injected code includes a uCode patch, and wherein execution of the injected code patches processor uCode.

3. The method of claim 2, wherein execution of the injected code produces and programs a new Machine Specific Register (MSR).

4. The method of claim 1, wherein execution of the injected code is used to effect one or more of a profile reconfiguration, a policy reconfiguration, and a security fix.

5. The method of claim 1, wherein the secure execution mode is System Management Mode (SMM).

6. The method of claim 5, wherein the code injection listener is an SMM code injection listener that is installed as part of SMM infrastructure code during booting of the computing system.

7. The method of claim 5, wherein the code injection listener is an SMM code injection listener, further comprising:
executing the SMM code injection listener using a first processor privilege level to extract injected code from the secure execution mode code injection image; and
executing the injected code that is extracted using a second processor privilege level having a lower privilege level than the first processor level.

8. The method of claim 1, further comprising:
during booting of the computing system,
producing a BIOS-OS interface for delivering a secure execution mode code injection image during OS runtime;
during OS runtime operation of the computing system,
receiving the secure execution mode code injection image via a network or fabric to which the computing system is coupled; and
utilizing the BIOS-OS interface to deliver the secure execution mode code injection image to the BIOS.

9. The method of claim 1, wherein the computing system further includes a management unit, further comprising:
during booting of the computing system,
configuring an out-of-band channel to deliver the secure execution mode code injection image from the management unit to the BIOS; and
during OS runtime operation of the computing system,
receiving the secure execution mode code injection image at the management unit; and
delivering the secure execution mode code injection image to the BIOS using the out-of-band channel.

10. The method of claim 1, wherein the BIOS comprises Unified Extensible Firmware Interface (UEFI) firmware, further comprising:
receiving a UEFI capsule containing the secure execution mode code injection image with injected code comprising an EFI driver;
delivering the UEFI capsule to the UEFI firmware;
executing UEFI firmware to extract the EFI driver; and
executing the EFI driver.

11. A computing platform, comprising:
a processor;
system memory, operatively coupled to the processor;
a firmware storage device in which firmware instructions comprising a plurality of firmware components are stored; and
an operating system (OS),
wherein, firmware instructions are configured to be executed on the processor to enable the computing platform to:
install a code injection listener during booting of the computer system;
during an execution mode of the processor comprising an OS runtime mode under which the operating system is executed on the processor and after a code injection image including injected code has been delivered to a firmware component,
switch to a secure execution mode and while in the secure execution mode,
extract injected code from the code injection image; and
execute injected code on the processor; and
exit the secure execution mode and return to the OS runtime mode.

12. The computing platform of claim 11, wherein the processor includes microcode (uCode), wherein the injected code includes a uCode patch, and wherein execution of the injected code patches the processor uCode.

13. The computing platform of claim 11, wherein execution of the injected code is used to effect one or more of a profile or policy reconfiguration and a security fix.

14. The computing platform of claim 11, wherein the secure execution mode is System Management Mode (SMM), and wherein the code injection listener is an SMM code injection listener that is installed as part of SMM infrastructure code.

15. The computing platform of claim 11, wherein a portion of the firmware components comprise BIOS and wherein execution of the firmware instructions further enables the computing platform to:
during booting of the computing platform,
produce a BIOS-OS interface for delivering a code injection image during OS runtime to BIOS,
wherein the operating system is configured to utilize the BIOS-OS interface to deliver a code injection image to the BIOS.

16. A non-transitory machine-readable medium having firmware instructions comprising a plurality of firmware components stored thereon configured to be executed on processor in a computing platform having system memory and an operating system, wherein execution of the firmware instructions enable to computing platform to:
install a code injection listener during booting of the computing platform;
during an execution mode of the processor comprising an operating system runtime mode under which an operating system is executed on the processor and after a code injection image including injected code has been delivered to a firmware component,
switch to a secure execution mode and while in the secure execution mode,
access injected code from the code injection image; and
execute injected code on the processor; and
switch back to the operating system runtime mode.

17. The non-transitory machine-readable medium of claim 16, wherein the processor includes microcode (uCode), wherein the injected code includes a uCode patch, and wherein execution of the injected code patches the processor uCode.

18. The non-transitory machine-readable medium of claim 16, wherein execution of the injected code is used to effect one or more of a profile reconfiguration, a policy reconfiguration, and a security fix.

19. The non-transitory machine-readable medium of claim 16, wherein the secure execution mode is System Management Mode (SMM), and wherein the code injection listener is an SMM code injection listener that is installed as part of SMM infrastructure code via execution of the firmware instructions.

20. The non-transitory machine-readable medium of claim 16, wherein a portion of the firmware components comprise BIOS and wherein execution of the firmware instructions further enables the computing platform to:
during booting of the computing platform,
produce a BIOS-OS interface for delivering a code injection image during OS runtime to BIOS,
wherein the operating system is configured to utilize the BIOS-OS interface to deliver a code injection image to the BIOS during the operating system runtime mode.
